(19) United States
(12) Patent Application Publication
(10) Pub. No.: US 2025/0384878 A1
(43) Pub. Date: Dec. 18, 2025

(54) SPEECH RECOGNITION METHOD AND APPARATUS, AND ELECTRONIC DEVICE

(71) Applicants: Lemon Inc., Grand Cayman (KY); DOUYIN VISION CO., LTD., Beijing (CN)

(72) Inventors: Ming TU, Los Angeles, CA (US); Lu LIU, Beijing (CN); Rui XIA, Los Angeles, CA (US); Xin LI, Beijing (CN); Chuanzeng HUANG, Beijing (CN); Yuxuan WANG, Los Angeles, CA (US)

(21) Appl. No.: 18/877,559

(22) PCT Filed: Oct. 20, 2023
(86) PCT No.: PCT/CN2023/125743

§ 371 Date: Dec. 20, 2024

(30) Foreign Application Priority Data
Nov. 10, 2022 (CN) 202211407243.8

(51) Int. Cl. G10L 15/183; G06F 40/279

(52) U.S. Cl. CPC G10L 15/183; G06F 40/279

(57) ABSTRACT

A speech recognition method and apparatus, and an electronic device. The method comprises: obtaining a first speech; obtaining a first text corresponding to a previous segment of speech of the first speech; obtaining a first set, the first set comprising a plurality of text identifications and a text feature corresponding to each of the plurality of text identifications, the text feature being a feature associated with a plurality of subsequent texts of a text corresponding to the text identification, the text feature being associated with frequencies of the plurality of subsequent texts of the text in a text set, and the first set being determined based on the text set; and determining, based on the first text and the first set, text content associated with the first speech.

### CROSS-REFERENCE TO RELATED APPLICATIONS

The present application is a U.S. National Stage Application of PCT International Application No. PCT/CN2023/125743, filed on Oct. 20, 2023, which claims priority to Chinese Patent Application No. 202211407243.8, filed with the China National Intellectual Property Administration on Nov. 10, 2022, and entitled “SPEECH RECOGNITION METHOD AND APPARATUS, AND ELECTRONIC DEVICE”, the disclosures of which are incorporated herein by reference in their entireties.

### FIELD

Embodiments of the present disclosure relate to the technical field of speech processing, and in particular, to a speech recognition method and apparatus, and an electronic device.

### BACKGROUND

Speech recognition technology can convert speech information into text information. For example, an electronic device may use automatic speech recognition technology to convert a segment of speech into text and display the text corresponding to the speech.

### SUMMARY

The present disclosure provides a speech recognition method and apparatus, and an electronic device, to solve the technical problem that the accuracy of speech recognition in the prior art is low.

In a first aspect, the present disclosure provides a speech recognition method. The speech recognition method includes:
obtaining a first speech;
obtaining a first text corresponding to a previous segment of speech of the first speech;
obtaining a first set, wherein the first set includes a plurality of text identifications and text features corresponding to each of the plurality of text identifications, the text features are features associated with a plurality of subsequent texts of a text corresponding to the text identification, the text features are associated with a frequency of the plurality of subsequent texts of the text within a text set, and the first set is determined based on the text set; and
determining, based on the first text and the first set, a text content associated with the first speech.

In a second aspect, the present disclosure provides a speech recognition apparatus, including a first obtaining module, a second obtaining module, a third obtaining module, and a determination module, wherein
the first obtaining module is configured to obtain a first speech;
the second obtaining module is configured to obtain a first text corresponding to a previous segment of speech of the first speech;
the third obtaining module is configured to obtain a first set, wherein the first set includes a plurality of text identifications and text features corresponding to each of the plurality of text identifications, the text features are features associated with a plurality of subsequent texts of a text corresponding to the text identification, the text features are associated with a frequency of the plurality of subsequent texts of the text within a text set, and the first set is determined based on the text set; and
the determination module is configured to determine, based on the first text and the first set, a text content associated with the first speech.

In a third aspect, an embodiment of the present disclosure provides an electronic device, including: a processor and a memory,
wherein the memory stores computer-executable instructions; and
the computer-executable instructions stored in the memory, when executed by the processor, cause the at least one processor to perform the speech recognition method according to the first aspect and various speech recognition methods possibly involved in the first aspect.

In a fourth aspect, an embodiment of the present disclosure provides a computer-readable storage medium. The computer-readable storage medium stores computer-executable instructions which, when executed by a processor, cause the processor to implement the speech recognition method according to the first aspect and various speech recognition methods possibly involved in the first aspect.

In a fifth aspect, an embodiment of the present disclosure provides a computer program product, including a computer program. The computer program, when executed by a processor, causes the processor to implement the speech recognition method according to the first aspect and various speech recognition methods possibly involved in the first aspect.

### BRIEF DESCRIPTION OF THE DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show some embodiments of the present disclosure, and persons of ordinary skill in the art may still derive other accompanying drawings from these accompanying drawings without creative efforts.

FIG. 1 is a schematic diagram of an application scenario according to embodiments of the present disclosure;

FIG. 2 is a schematic flowchart of a speech recognition method according to embodiments of the present disclosure;

FIG. 3A is a schematic diagram of a process of obtaining a first text according to embodiments of the present disclosure;

FIG. 3B is a schematic diagram of another process of obtaining a first text according to embodiments of the present disclosure;

FIG. 4 is a schematic diagram of a process of obtaining a first text feature according to embodiments of the present disclosure;

FIG. 5 is a schematic diagram of a process of determining a second text according to embodiments of the present disclosure;

FIG. 6 is a schematic diagram of a method for obtaining a first set according to embodiments of the present disclosure;

FIG. 7 is a schematic diagram of a process of determining an initial set according to embodiments of the present disclosure;

FIG. 8 is a schematic diagram of a process of updating a first text feature according to embodiments of the present disclosure;

FIG. 9 is a schematic diagram of a process of a speech recognition method according to embodiments of the present disclosure;

FIG. 10 is a schematic diagram of a structure of a speech recognition apparatus according to embodiments of the present disclosure; and

FIG. 11 is a schematic diagram of a structure of an electronic device according to embodiments of the present disclosure.

### DETAILED DESCRIPTION OF EMBODIMENTS

Exemplary embodiments are described in detail herein, with examples shown in the accompanying drawings. When the following description involves the accompanying drawings, unless otherwise indicated, the same numerals in different accompanying drawings represent the same or similar elements. Implementations described in the following exemplary embodiments do not represent all implementations consistent to the present disclosure. On the contrary, these implementations are only examples of apparatuses and methods consistent to some aspects of the present disclosure described in detail in the appended claims.

For ease of understanding, the following is an explanation of concepts involved in the embodiments of the present disclosure.

Electronic device: a device with a wireless sending and receiving function. The electronic device may be deployed on land, including indoor or outdoor, handheld, wearable, or vehicle-mounted. The electronic device may be a mobile phone, a tablet computer (Pad), a computer with a wireless sending and receiving function, a virtual reality (VR) electronic device, an augmented reality (AR) electronic device, a wireless terminal in industrial control, a vehicle-mounted electronic device, a wireless terminal in self driving, a wireless electronic device in remote medical care, a wireless electronic device in smart grid, a wireless electronic device in transportation safety, a wireless electronic device in smart city, a wireless electronic device in smart home, a wearable electronic device, etc. The electronic device involved in the embodiments of the present disclosure may also be referred to as a terminal, user equipment (UE), an access electronic device, a vehicle-mounted terminal, an industrial control terminal, a UE unit, a UE station, a mobile station, a mobile platform, a remote station, a remote electronic device, a mobile device, a UE electronic device, a wireless communication device, a UE agent, or a UE apparatus, etc. The electronic device may also be fixed or mobile.

In the related art, during speech recognition, a language model may be added to a speech recognition model. The language model can predict a next segment of text corresponding to a text associated with the current speech. The language model can assist the speech recognition model in recognizing the next segment of speech. For example, when the speech recognition model obtains a text, the language model may predict a next text of the text. The speech recognition model predicts a next segment of speech through a next segment of acquired speech and the next text predicted by the language model.

However, samples in training sets of the speech recognition model and the language model are typically samples obtained from the internet, and the training sets obtained from the internet contain a small number of long-tail words (less frequently used words). The speech recognition model and the language model cannot learn more long-tail word information in a training process, resulting in low recognition accuracy for the long-tail words by the speech recognition model and the language model, leading to low accuracy in speech recognition.

To solve the above technical problem, an embodiment of the present disclosure provides a speech recognition method. An electronic device obtains a first speech and a first text corresponding to a previous segment of speech of the first speech. The electronic device may obtain a first set, wherein the first set includes a plurality of text identifications and a text feature corresponding to each of the plurality of text identifications, and the text feature is a feature associated with a subsequent text corresponding to the text identification. The lower the frequency of the subsequent text in a text set, and the more features of the subsequent text are fused into the text feature. The electronic device may determine, based on the first text and the first set, a next segment of second text of the first text, and determine, based on the second text and the first speech, text content associated with the first speech. In this way, since the text features in the first set are associated with the frequency of a plurality of subsequent texts of the text within the text set, the first set may include more long-tail word information. The electronic device may obtain more contextual information of the first text through a first text feature, thereby improving the accuracy of prediction of the next segment of text (i.e., a predicted text of the first speech). Then, the first speech is accurately recognized in combination with the next segment of text, thereby improving the accuracy of speech recognition.

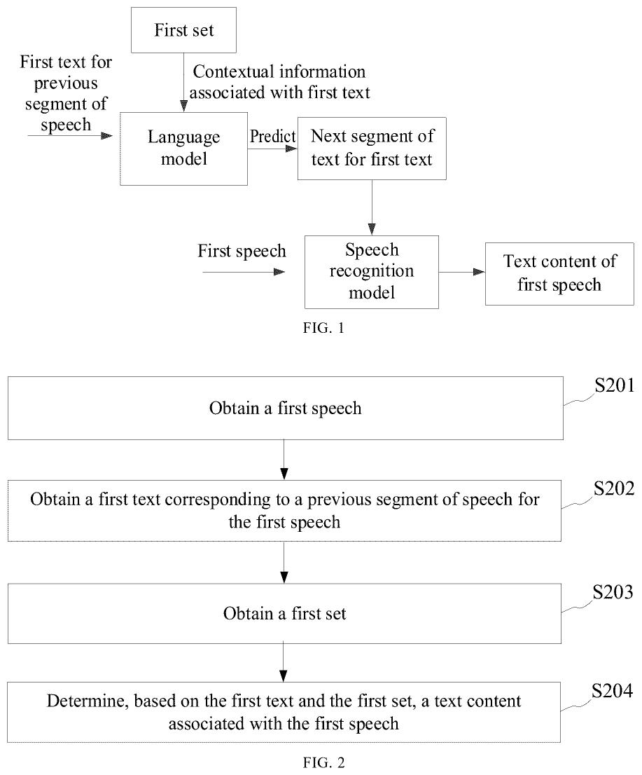

Next, an application scenario of the embodiments of the present disclosure is described with reference to FIG. 1.

FIG. 1 is a schematic diagram of an application scenario according to embodiments of the present disclosure. Referring to FIG. 1, a language model, a speech recognition model, and a first set are shown. A first text of a previous segment of speech of a first speech is input into the language model. The language model may obtain, based on an identification of the first text, contextual information associated with the first text from the first set, and then predict a next segment of text of the first text based on the first text and the contextual information associated with the first text. When the speech recognition model obtains the first speech, the speech recognition model may determine text content of the first speech based on the next segment of text and the first speech. In this way, when the next segment of text is predicted through the first text, a text prediction model may obtain the contextual information associated with the first text from the first set. Therefore, the text prediction model can accurately predict the next segment of text corresponding to the previous segment of speech of the first speech, thereby assisting the speech recognition model in accurately recognizing the first speech and improving the accuracy of speech recognition.

It is to be noted that FIG. 1 is merely an example illustrating the application scenario of the embodiments of the present disclosure and is not intended to limit the application scenario of the embodiments of the present disclosure.

The technical solutions of the present disclosure and how the technical solutions of the present disclosure solve the above technical problem are described below in detail with specific embodiments. The following several specific embodiments may be combined with each other, and details about same or similar concepts or processes may not be described in some embodiments again. The embodiments of the present disclosure are described below with reference to the accompanying drawings.

FIG. 2 is a schematic flowchart of a speech recognition method according to embodiments of the present disclosure. Referring to FIG. 2, the method may include the following steps.

S201: Obtain a first speech.

An execution entity of this embodiment of the present disclosure may be an electronic device or a speech recognition apparatus disposed in the electronic device. The speech recognition apparatus may be implemented through software, or through a combination of software and hardware. This is not limited in this embodiment of the present disclosure.

Optionally, the first speech may be any speech obtained by the electronic device. For example, the first speech may be a real-time speech of a user acquired by the electronic device, or may be a stored speech obtained from an internal memory of the electronic device. Alternatively, the electronic device may obtain the first speech through another electronic device. This is not limited in this embodiment of the present disclosure. For example, the electronic device may receive a speech sent by another electronic device and determine the speech as the first speech.

It is to be noted that the first speech may be a speech of any length. For example, the first speech may include 1 syllable, 2 syllables, or 3 syllables, etc. Alternatively, the first speech may be a 1-second speech, a 2-second speech, or a 3-second speech, etc. This is not limited in this embodiment of the present disclosure.

S202: Obtain a first text corresponding to a previous segment of speech of the first speech.

Optionally, the first text may include a text character. For example, the first text may be a text composed of 1 character, or a text composed of 2 characters. This is not limited in this embodiment of the present disclosure. Optionally, the previous segment of speech of the first speech may include one or more words or Chinese characters. This is not limited in this embodiment of the present disclosure.

Optionally, after obtaining the first speech, the electronic device may obtain the previous segment of speech of the first speech based on the first speech, and may use automatic speech recognition (ASR) technology to recognize the previous segment of speech of the first speech, thereby obtaining the first text. For example, if the previous segment of speech of the first speech obtained by the electronic device is “Nihao( [symbol] (Hello))”, the electronic device may use the ASR technology to convert the previous segment of speech of the first speech into the text “Nihao”.

Optionally, the electronic device may determine entered text as the first text. For example, if the user enters the text “Ni” into the electronic device, the electronic device may determine the text “Ni” as the first text; if the user enters the text “Nihao” into the electronic device, the electronic device may determine the text “Nihao” as the first text; and if the user enters the text “Jintian tianqi zhen hao ( [symbol] (The weather is lovely today))” into the electronic device, the electronic device may determine the text “Jintian tianqi zhen hao” as the first text.

It is to be noted that when the number of characters of the first text is large, the electronic device may determine the last M characters (M is greater than 1 and less than the number of the characters of the first text) in the first text as the first text, thereby improving the accuracy of text prediction. For example, if the text entered by the user into the electronic device is “Jintian tianqi zhen hao”, the electronic device may determine the text “hao” as the first text, or may determine the text “zhen hao” as the first text. This is not limited in this embodiment of the present disclosure.

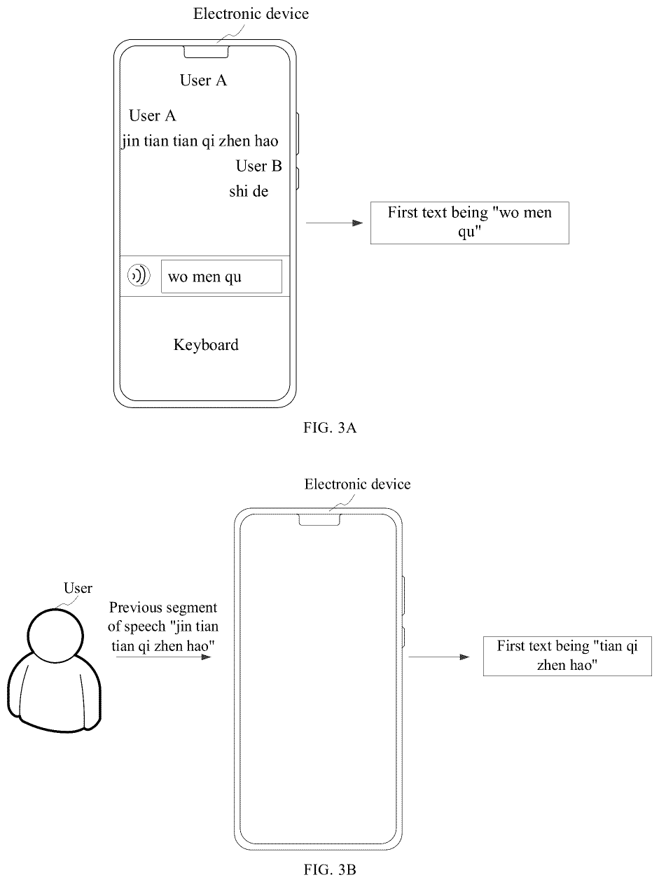

Next, the process of obtaining the first text is described with reference to FIG. 3A and FIG. 3B.

FIG. 3A is a schematic diagram of a process of obtaining a first text according to embodiments of the present disclosure. Referring to FIG. 3A, an electronic device is included. A display page of the electronic device is a chat page between a user B (the user of the electronic device) and a user A. The user A sends a text “Jintian tianqi zhen hao”, the user B replies with a text “Shide ( [symbol] (Yes))”, and the user B enters a text “Women qu ( [symbol] (Let's go))” through a keyboard, and the electronic device determines that the first text is “Women qu”.

FIG. 3B is a schematic diagram of another process of obtaining a first text according to embodiments of the present disclosure. Referring to FIG. 3B, an electronic device and a user are included. A previous segment of speech sent by the user to the electronic device is “Jintian tianqi zhen hao”. After receiving the speech, the electronic device may use the ASR technology to convert the speech into the text “Jintian tianqi zhen hao”, and determine that the first text is the last 4 characters of the text, which are “tianqi zhen hao”. In this way, the electronic device may obtain the first text through the speech of the user, thereby improving flexibility and efficiency of text obtaining.

S203: Obtain a first set.

Optionally, the first set includes a plurality of text identifications and a text feature corresponding to each of the plurality of text identifications. For example, the first set may include a plurality of correspondences, each of which includes one text identification and one text feature. For example, the first set may be a dictionary that may include a plurality of key-value pairs.

Optionally, the text identification may be a key value of a text. For example, the text identification may be a key value associated with a text character. For example, if a text includes 1 character, a text identification of the text is a key value corresponding to the character. If a text includes 2 characters, a text identification corresponding to the text may be determined based on the 2 characters. For example, the electronic device may obtain a plurality of texts from a text set, then determine a text identification corresponding to each text, and add the text identification to the first set in a construction process of the first set.

Optionally, for any text in the first set, the electronic device may determine the text identification of the text based on the following feasible implementation: determining a character identification corresponding to each character in the text and the number of texts in the first set. Optionally, the character identification may be a sequence number of the text in the first set, and the number of texts may be the total number of texts in the first set. For example, if the first set may include 10,000 texts, the number of texts is 10,000. For example, if the first set includes 10,000 texts, the sequence number of a text A is 2,000, and the sequence number of a text B is 3,000, the character sequence number of the text A is 2,000, and the character sequence number of the text B is 3,000.

Optionally, the text identification is determined based on the character identification and the number of texts. For example, if the character identification corresponding to the text is 2,000, and the number of texts is 10,000, the text identification corresponding to the text is 2,000 mod 10,000, where mod is a modulo operator. In this way, text identifications corresponding to the plurality of texts may be determined through the method.

Optionally, the text feature is a feature associated with a plurality of subsequent texts of a text corresponding to the text identification. For example, when constructing the first set, the electronic device further needs to obtain a text feature corresponding to subsequent texts associated with each text. For any text, the subsequent texts are all subsequent texts corresponding to the text in the text set. For example, for a text “Wo”, if the text set includes sentences “Women yiqi qu jiaoyou( [symbol] (Let's go on an outing together))” and “Wo chi guo le( [symbol] (I've eaten))”, subsequent texts of the text “Wo” are texts “men” and “chi”. The electronic device may obtain a character feature corresponding to the text “men” and a character feature corresponding to the text “chi”, and determine a text feature corresponding to the text “Wo” based on the two character features.

It is to be noted that the first set is determined based on the text set. The text set may be a training sample set or any set including a plurality texts. This is not limited in this embodiment of the present disclosure.

It is to be noted that the first set includes the text identification corresponding to the first text. Therefore, when predicting the next segment of text for the first text, the electronic device may obtain information about the subsequent texts associated with the first text from the first set, thereby assisting the electronic device in predicting the next segment of text and improving the accuracy of text prediction.

Optionally, the text features are associated with a frequency of the plurality of subsequent texts for the text within the text set. For example, if the frequency of a subsequent text within the text set is high, the electronic device may reduce the proportion of a feature corresponding to the subsequent text in the text features. If the frequency of a subsequent text within the text set is low, the electronic device may increase the proportion of a feature corresponding to the subsequent text in the text features. In this way, each text feature in the first set may fuse more low-frequency words, thereby improving the accuracy of text prediction.

It is to be noted that the frequency of the subsequent texts in the text set is the frequency of a combination of the text and the subsequent texts occurring in the text set. For example, a subsequent text of the text “wo” is “men”, and if the phrase “women” occurs 1,000 times in the text set, it is determined that the frequency corresponding to the subsequent text “men” is 1,000 times. If a text “tamen” occurs in the text set, although the text “men” occurs in this phrase, the text “men” is unrelated to the text “wo”. For the phrase “women”, the frequency of occurrence of the subsequent text “men” of the text “wo” is not affected.

S204: Determine, based on the first text and the first set, text content associated with the first speech.

Optionally, the electronic device may determine the text content associated with the first speech based on the following feasible implementation: determining, based on the first text and the first set, a next segment of second text of the first text, and determining, based on the second text and the first speech, the text content associated with the first speech.

Optionally, the second text may be a next segment of text of the first text. For example, if a segment of text is “women”, and the first text is “wo”, the second text is “men”. In this embodiment of the present disclosure, the electronic device may predict that the next text is “men” based on the text “wo”.

It is to be noted that since the first text is the text corresponding to the previous segment of speech of the first speech, the second text is the next segment of text predicted by the electronic device based on the first text, and the second text is associated with the first speech.

Optionally, the electronic device determining, based on the first text and the first set, a second text which is the next segment for the first text is specifically: obtaining a first identification of the first text, obtaining, based on the first identification, a first text feature associated with a plurality of subsequent texts for the first text within the first set, and determining the second text based on the first text and the first text feature. It is to be noted that the method for obtaining the first identification of the first text is same as step S203, which is not repeated herein in this embodiment of the present disclosure.

Optionally, the first text feature may be a feature corresponding to the plurality of subsequent texts for the first text. For example, since the first set may include the identification corresponding to the first text, there are text features corresponding to the plurality of subsequent texts for the first text within the first set.

Optionally, the obtaining, based on the first identification, a first text feature associated with a plurality of subsequent texts for the first text within the first set is specifically: determining a target identification that is same as the first identification from the plurality of text identifications within the first set, and determining a text feature corresponding to the target identification as the first text feature. For example, the first set may include a plurality of indexes (each index may be a key-value pair, i.e., the text identifications and the text features corresponding to the text identifications included in the first set). Each index may indicate a correspondence between a key value and a text feature. After obtaining the key value corresponding to the first text, the electronic device obtains a text feature corresponding to the key value from the first set and determines the text feature as the first text feature. For example, the first set includes an index of a key value A-text feature A and an index of a key value B-text feature B. If the electronic device obtains the key value of the first text as the key value A, the first text feature associated with the plurality of subsequent texts for the first text is the text feature A. If the electronic device obtains the key value of the first text as the key value B, the first text feature associated with the plurality of subsequent texts for the first text is the text feature B.

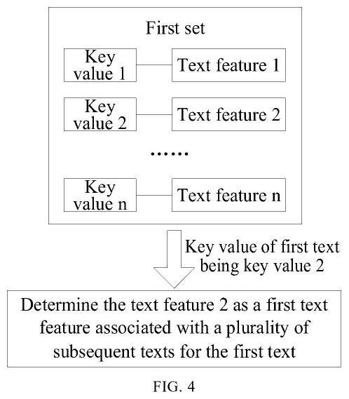

Next, the process of obtaining the first text feature is described with reference to FIG. 4.

FIG. 4 is a schematic diagram of a process of obtaining a first text feature according to embodiments of the present disclosure. Referring to FIG. 4, a first set is included. The first set includes n key values, and a text feature corresponding to each key value. For example, the first set may include a key value 1-text feature 1, a key value 2-text feature 2, . . . , and a key value n-text feature n, wherein the text feature is a feature associated with a plurality of subsequent texts of a text corresponding to the key value.

Referring to FIG. 4, if the key value corresponding to the first text obtained by the electronic device is the key value 2, the electronic device may obtain the text feature 2 corresponding to the key value 2 within the first set, and determine the text feature 2 as the first text feature associated with the plurality of subsequent texts for the first text. In this way, the electronic device may accurately obtain contextual information about the first text from the first set, thereby improving the accuracy of predicting the next segment of text for the first text.

Optionally, the electronic device determining, based on the first text and the first text feature, a second text is specifically: determining, based on the first text, a context feature associated with the first text. For example, the electronic device may obtain, based on a feature extraction model, the context feature associated with the first text. For example, a sentence containing the first text includes a character A, a character B, and a character C. If the first text is the character C, the electronic device may obtain, based on the feature extraction model, a context feature associated with the character C, and the context feature includes information about the character A, the character B, and the character C.

The second text is determined based on the context feature and the first text feature. Optionally, the electronic device may determine the second text based on the following feasible implementation: fusing the first text feature and the context feature to obtain a fused feature, and determining the second text based on the fused feature. For example, the electronic device may fuse the first text feature and a second text feature through an attention mechanism to obtain the fused feature. Then, the fused feature is processed through a text prediction module (which may be a convolutional layer in an existing text prediction model, e.g., an output layer of the text prediction model) to obtain the second text. In this way, the fused feature not only includes the context feature of the first text but also includes the contextual information stored in the first set, the contextual information in the first set has a high proportion of low-frequency words, and therefore the electronic device may obtain the accurate second text, thereby improving the accuracy of text prediction.

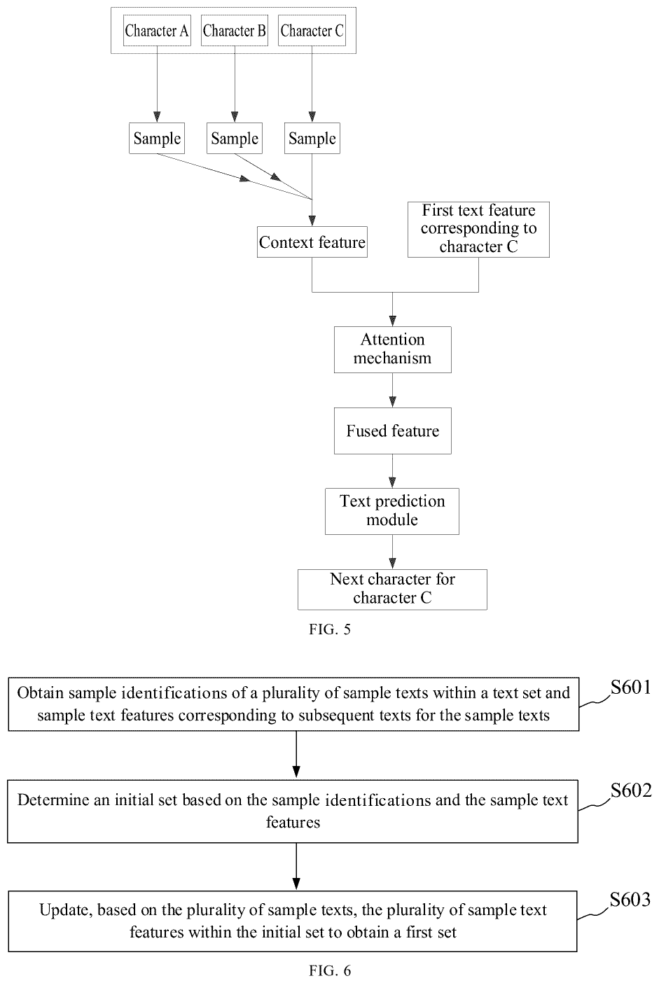

Next, the process of determining the second text is described with reference to FIG. 5.

FIG. 5 is a schematic diagram of a process of determining a second text according to embodiments of the present disclosure. Referring to FIG. 5, a character A, a character B, and a character C are included. The character A, the character B, and the character C are 3 characters in a sentence. The character A, the character B, and the character C are sampled to obtain sampling information, and a context feature corresponding to the character C is obtained through the sampling information of the character A, the sampling information of the character B, and the sampling information of the character C.

Referring to FIG. 5, the context feature corresponding to the character C and a first text feature corresponding to the character C (which may be obtained from the first set) are processed through the attention mechanism to obtain a fused feature corresponding to the character C, and the text prediction module processes the fused feature to obtain a next character for the character C. In this way, when text prediction is performed, the electronic device not only obtains the context feature of the contextual information including the character C but also obtains a plurality of pieces of subsequent character information of the character C from the first set, thereby improving the accuracy of text prediction.

Optionally, the electronic device determining, based on the second text and the first speech, a text content associated with the first speech is specifically: performing text recognition processing on the first speech to obtain a third text. For example, the electronic device may recognize the first speech through the ASR technology to obtain the third text.

The text content associated with the first speech is determined based on the second text and the third text. For example, if the second text and the third text are the same, the electronic device may determine the second text or the third text as the text content associated with the first speech; and if the second text and the third text are different, the electronic device may determine the text content associated with the first speech based on a distribution probability of the second text and a distribution probability of the third text. For example, if the distribution probability of the text recognized by the ASR is 70%, and the distribution probability of the text predicted by the method according to this embodiment of the present disclosure is 30%, the electronic device may randomly determine, based on the above distribution probabilities, the second text or the third text as the text content associated with the first speech.

It is to be noted that in this embodiment of the present disclosure, based on the second text and the third text, the text content of the first speech may also be determined through other methods (e.g., a method for correcting the third text based on the second text). This is not limited in this embodiment of the present disclosure. In this way, since the second text is predicted based on more long-tail word information, the speech recognition model may be assisted in recognizing the first speech based on the second text, thereby improving the accuracy of speech recognition.

It is to be noted that the second text in this embodiment of the present disclosure may also include a plurality of pieces of text information, and the text content of the first speech is determined through the plurality of pieces of text information and the third text. For example, the second text may include a plurality of subsequent texts for the first text, and then the text content of the first speech is determined through the plurality of subsequent texts and the third text. For example, the first text of the previous speech corresponding to the first speech is “women”, the third text of the first speech is “qu”, and the second text which is the next segment for the first text may include a text “qu”, a text “chi”, and a text “zou”. The electronic device may determine the text content of the first speech as “qu” based on the plurality of pieces of text information included in the second text. In this way, when the text content corresponding to the first speech is a long-tail word, even if the ASR cannot accurately recognize the text of the first speech, the text content recognized by the ASR may still be corrected through the second text, thereby improving the accuracy of text recognition.

According to the speech recognition method provided by this embodiment of the present disclosure, the electronic device obtains the first speech and the first text corresponding to the previous segment of speech of the first speech. The electronic device may obtain the first set, determine, based on the first text and the first set, the second text which is the next segment of the first text, and determine, based on the second text and the first speech, the text content associated with the first speech. In this way, since the text features in the first set are associated with the frequency of the plurality of subsequent texts for the text within the text set, the first set may include more long-tail word information. The electronic device may obtain more contextual information about the first text through the first text feature, thereby improving the prediction accuracy of the next segment of text. Furthermore, the first speech is accurately recognized in combination with the next segment of text, thereby improving the accuracy of speech recognition.

Based on the embodiment shown in FIG. 2, the above speech recognition method also includes a method for obtaining the first set. Next, the method for obtaining the first set is described with reference to FIG. 6.

FIG. 6 is a schematic diagram of a method for obtaining a first set according to embodiments of the present disclosure. Referring to FIG. 6, the process of the method includes:

S601: Obtain sample identifications of a plurality of sample texts within a text set and sample text features corresponding to subsequent texts for the sample texts.

Optionally, before constructing the first set, the electronic device needs to determine the size of the first set. For example, the electronic device may construct the first set as a matrix of U×M×d_{emb}, where U may be the size of the set. For example, if U is 10000, the first set may store text features corresponding to 10000 texts. M may be a preset hyperparameter. For example, M may indicate the number of vectors that can be allocated to each entry in the set, and the entries are used to store text features of subsequent characters. A larger M allows for storing more text features of subsequent texts. d_{emb} may be the dimension of the text features.

Optionally, the text set may include a plurality of sample texts, and the electronic device may obtain sample identifications corresponding to the plurality of sample texts and sample text features corresponding to subsequent texts for the sample texts. Optionally, the sample identification may be a key value corresponding to the sample text. For example, if the sample text is a character A, the sample identification may be a result of a mod operation between a character sequence number of the character A and the number of texts in the text set. It is to be noted that the method for obtaining a key value has been described in detail in step S202, which is not repeated herein in this embodiment of the present disclosure.

Optionally, the sample text feature may be a feature corresponding to the subsequent texts for the sample text. For example, if a sentence is “women”, and a sample text is “wo”, a subsequent text for the sample text is “men”, and the sample text feature is a feature (embedding) corresponding to “men”.

Optionally, for any sample text, the electronic device may obtain features corresponding to all subsequent texts for the sample text within the text set, thereby obtaining the sample text features. For example, for the text “wo”, the electronic device may obtain subsequent texts for the text “wo” within the text set. If the text set includes texts “women”, “wo chi”, “wo qu”, and “wo lai”, the electronic device determines that the subsequent texts for the text “wo” include “men”, “chi”, “qu”, and “lai”, and the electronic device may obtain a feature corresponding to each subsequent text.

Optionally, in a practical application process, the plurality of sample texts within the text set are used to train the text prediction model. Therefore, the feature corresponding to each subsequent text may be obtained in the convolutional layer of the text prediction model. For example, when the text prediction model is trained through the plurality of sample texts within the text set, parameters of a feature extraction network includes embedding corresponding to each text, and the electronic device may obtain embedding of each subsequent text based on the parameters of the feature extraction network. Therefore, the feature obtaining efficiency can be improved.

S602: Determine an initial set based on the sample identifications and the sample text features.

Optionally, the initial set includes a plurality of sample identifications and a sample text feature corresponding to each sample identification. For example, after obtaining the sample identification corresponding to each sample text and the sample text feature corresponding to a plurality of subsequent texts for each sample text, the electronic device may establish an index for the set, and obtain the initial set after the index is established. For example, the electronic device may obtain a key value corresponding to each sample text and associate the key value with the feature of the plurality of subsequent texts for the sample text to obtain a key-value pair. In this way, each key value may be associated with a matrix of M×d_{emb}, and the matrix may store information about the subsequent texts for the text corresponding to the key value.

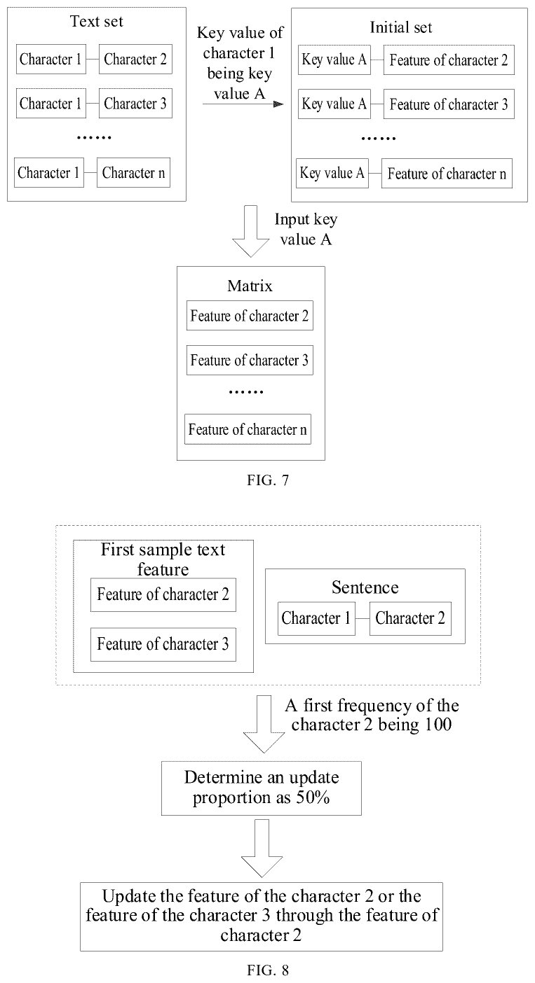

Next, the process of determining the initial set is described with reference to FIG. 7.

FIG. 7 is a schematic diagram of a process of determining an initial set according to embodiments of the present disclosure. According to the embodiment shown in FIG. 7, a character 1 is used as an example to describe the obtaining of a content associated with the character 1 in the initial set. Referring to FIG. 7, a text set is included, and includes the character 1, a character 2, a character 3, . . . , and a character n, where the character 2, the character 3, . . . , and the character n are subsequent texts for the character 1.

Referring to FIG. 7, if a key value of the character 1 is the key value A, the electronic device may construct n key-value pairs corresponding to the character 1, where the n key-value pairs may include a feature of a key value A-character 2, a feature of a key value A-character 3, . . . , and a feature of a key value A-character n, thereby obtaining the initial set. In the initial set, a matrix corresponding to the key value A includes a feature of the character 2, a feature of the character 3, . . . , and a feature of the character n.

S603: Update, based on the plurality of sample texts, the plurality of sample text features within the initial set to obtain the first set.

Optionally, after obtaining the initial set, the electronic device may update the plurality of sample text features within the initial set, such that the sample text features may include more low-frequency word information, thereby improving the accuracy of text prediction.

Optionally, for any first sample text from the plurality of sample texts, the updating, based on the first sample text, the plurality of sample text features within the initial set is specifically: obtaining a first sample identification corresponding to the first sample text and subsequent sample texts for the first sample text. For example, in a practical application process, a plurality of sentences within the text set may include a plurality of subsequent sample texts corresponding to the first sample text. When the initial set is updated, each sentence in the text set needs to be used to update the initial set. Therefore, the electronic device may obtain any subsequent sample text for the first sample text or determine a subsequent text for the first sample text in the sentence currently used for update as the subsequent sample text. This is not limited in this embodiment of the present disclosure.

Optionally, a first sample text feature is determined within the initial set based on the first sample identification. For example, referring to FIG. 7, if the first sample text is the character 1, and the first sample identification corresponding to the first sample text is the key value A, the first sample text feature is a matrix corresponding to the key value A, that is, the first sample text feature includes the feature of the character 2, the feature of the character 3, . . . , and the feature of the character n.

Optionally, a first frequency of occurrence of a combined text of the subsequent sample texts associated with the first sample text within the text set, as well as subsequent text features corresponding to the subsequent sample texts are obtained. For example, referring to FIG. 7, if the first sample text is the character 1 and the subsequent sample text is the character 2, the electronic device may determine the feature of the character 2 as the subsequent text feature. Moreover, the electronic device may obtain the number of occurrences of a combination of the character 1-character 2 within the text set. If the character 1-character 2 occurs 100 times, the electronic device determines the first frequency to be 100 times.

Optionally, the first sample text feature is updated based on the first frequency and the subsequent text features. Optionally, the electronic device may update the first sample text feature based on the following feasible implementation: determining an update proportion of the first sample text feature based on the first frequency, and randomly updating vectors in the first sample text feature based on the update proportion and the subsequent text features.

Optionally, the electronic device may randomly update the vectors in the first sample text feature based on the following formula:

$$= \{ \begin{matrix}{D}_{i}^{m} * α + {E}_{k + 1} * ( 1 - α ) & if {X}_{k + 1} = 1 \\ {D}_{i}^{m} & if {X}_{k + 1} = 0\end{matrix}$$

where Xₖ₊₁ has a Bernoulli distribution

$${P}_{k + 1} = \frac{1}{log ( First frequency )} ;$$

both [symbol] and

$${D}_{i}^{m}$$

are vectors of 1×d_{emb}, representing an m^{th} row in an initial dictionary indexed by a current key value i and [symbol] is a vector after updating

$${D}_{i}^{m} ;$$

Eₖ₊₁ represents a subsequent text feature; and α represents the smoothness of the update.

For example, if the first frequency is 100, log 100 is 2, and Pₖ₊₁ is 0.5. Therefore, the electronic device may randomly update 50% of the vectors in the first text feature based on the subsequent text feature. For example, the first text feature includes a vector A and a vector B, and if Pₖ₊₁ is 0.5, the electronic device may update either the vector A or the vector B based on the subsequent text feature. When the vector A is updated, α is between 0 and 1, if α is 1, the vector A is not updated, and if α is 0, the vector A is replaced with the subsequent text feature. In a practical application process, α may be 0.5. In this way, when the vector A is updated, some information about the vector A and some information about the subsequent text feature may be superposed, thereby improving an effect of feature fusion and thus improving the accuracy of text prediction.

Optionally, after the initial set is updated through each sample text within the text set, the first set is obtained. For example, if the text set includes 10000 texts, after the initial set is updated 10000 times through the 10000 texts, the first set corresponding to the initial set is obtained.

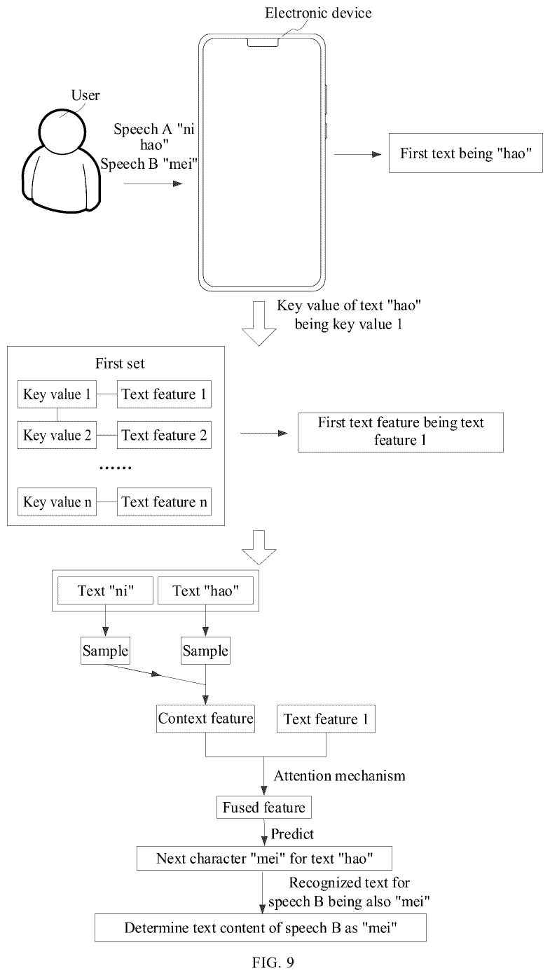

Next, the process of updating the first text feature is described with reference to FIG. 8.

FIG. 8 is a schematic diagram of a process of updating a first text feature according to embodiments of the present disclosure. Referring to FIG. 8, a first sample text feature associated with a character 1 and a sentence within a text set are included. The first sample text feature includes a feature of a character 2 and a feature of a character 3 (indicating that subsequent characters for the character 1 within the text set are only the character 2 and the character 3), and the sentence includes the character 1 (a first sample text) and the character 2 (a subsequent sample text).

Referring to FIG. 8, after the electronic device determines that the character 2 occurs 100 times after the character 1 and determines the first frequency of the character 2 as 100, and therefore the electronic device determines the update proportion corresponding to the first sample text feature to be 50%. The electronic device updates the feature of the character 2 or the feature of the character 3 within the first sample text feature through the feature of the character 2 (the subsequent text feature). In this way, when the frequency of the subsequent sample text is relatively low, the electronic device updates the first sample text feature with a high proportion, thereby allowing the first sample text to include more information about the subsequent sample text, and then improving the accuracy of text prediction.

According to the method for obtaining a first set provided by this embodiment of the present disclosure, the sample identifications of the plurality of sample texts within the text set and the sample text features corresponding to the subsequent texts for the sample texts are obtained. Based on the sample identifications and the sample text features, the initial set is determined. The initial set includes the plurality of sample identifications and the sample text feature corresponding to each sample identification. The plurality of sample text features within the initial set are updated based on the plurality of sample texts to obtain the first set. In this way, the text features in the first set may include more low-frequency word information. When the electronic device predicts the next segment of text for the text, the electronic device can not only obtain the contextual information from the text but also obtain more contextual information corresponding to the text from the first set, thereby improving the accuracy of text prediction and enhancing the accuracy of speech recognition.

Next, the process of the above speech recognition method is described with reference to FIG. 9.

FIG. 9 is a schematic diagram of a process of a speech recognition method according to embodiments of the present disclosure. Referring to FIG. 9, an electronic device, a user, and a first set are included. The first set includes a key-value pair of a key value 1-text feature 1, a key-value pair of a key value 2-text feature 2, . . . , and a key-value pair of key value n-text feature 3. When the user inputs a speech A “nihao” and a speech B “mei” to the electronic device, the electronic device may convert the speech A into a text “nihao” through the ASR technology and determine a last character in the text as a first text. The electronic device determines the first text as “hao”, where the speech A is a previous segment of speech for the speech B.

Referring to FIG. 9, the electronic device obtains a key value for the text “hao” as a key value 1. Therefore, the electronic device may obtain, based on the key value 1, a text feature 2 corresponding to the key value 1 from the first set and determine the text feature 2 as a first text feature corresponding to the text “hao” (the text feature may include features of a plurality of subsequent texts for the text “hao”).

Referring to FIG. 9, the electronic device performs sampling processing on the text “ni” and the text “hao” and obtains a context feature associated with the text “hao” based on sampling information about the text “ni” and sampling information about the text “hao”. The electronic device processes the context feature and the text feature 1 through the attention mechanism to obtain a fused feature.

Referring to FIG. 9, the electronic device may perform text prediction based on the fused feature, thereby obtaining the next character “mei” for the text “hao”. If a recognized text for the speech B, which is the next speech for the speech A “nihao”, is also “mei”, the electronic device may determine a text content of the speech B as mei. In this way, when the electronic device performs text prediction, since the electronic device can not only obtain the contextual information about the first text based on the sentence but also obtain more contextual information about the first text based the first set, the electronic device may accurately predict a next segment of text for the first text, thereby improving the accuracy of text prediction. Furthermore, the next segment of speech is accurately recognized in combination with the next segment of text, thereby improving the accuracy of speech recognition.

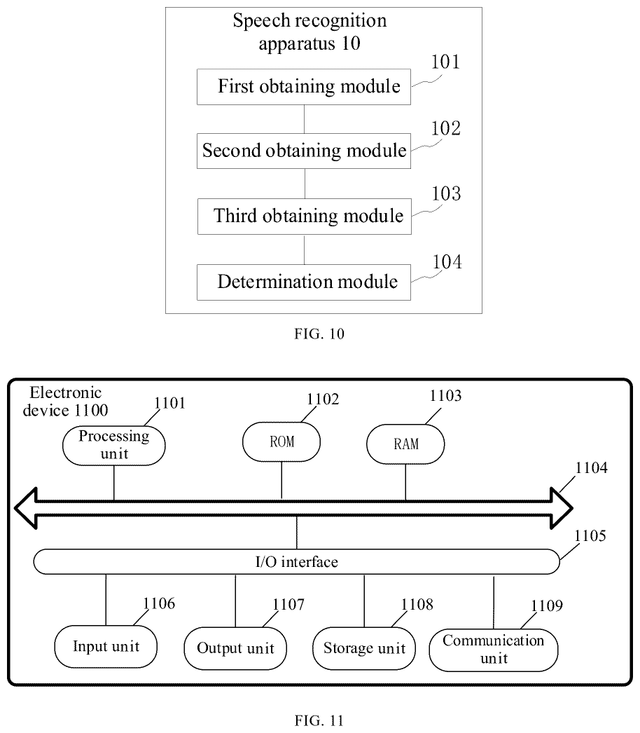

FIG. 10 is a schematic diagram of a structure of a speech recognition apparatus according to embodiments of the present disclosure. Referring to FIG. 10, the speech recognition apparatus 100 includes a first obtaining module 101, a second obtaining module 102, a third obtaining module 103, and a determination module 104, where
the first obtaining module 101 is configured to obtain a first speech;
the second obtaining module 102 is configured to obtain a first text corresponding to the first speech;
the third obtaining module 103 is configured to obtain a first set, wherein the first set includes a plurality of text identifications and text features corresponding to each of the plurality of text identifications, the text features are features associated with a plurality of subsequent texts of a text corresponding to the text identification, the text features are associated with a frequency of the plurality of subsequent texts of the text within a text set, and the first set is determined based on the text set; and
the determination module 104 is configured to determine, based on the first text and the first set, a text content associated with the first speech.

Based on one or more embodiments of the present disclosure, the determination module 104 is specifically configured to:
determine, based on the first text and the first set, a second text which is the next segment for the first text; and
determine, based on the second text and the first speech, a text content associated with the first speech.

Based on one or more embodiments of the present disclosure, the determination module 104 is specifically configured to:
obtain a first identification of the first text;
obtain, based on the first identification, a first text feature associated with a plurality of subsequent texts for the first text within the first set; and
determine the second text based on the first text and the first text feature.

Based on one or more embodiments of the present disclosure, the determination module 104 is specifically configured to:
determine a target identification that is same as the first identification from the plurality of text identifications within the first set; and
determine a text feature corresponding to the target identification as the first text feature.

Based on one or more embodiments of the present disclosure, the determination module 104 is specifically configured to:
determine, based on the first text, a context feature associated with the first text; and
determine the second text based on the context feature and the first text feature.

Based on one or more embodiments of the present disclosure, the determination module 104 is specifically configured to:
fuse the first text feature and the context feature to obtain a fused feature; and
determine the second text based on the fused feature.

Based on one or more embodiments of the present disclosure, the determination module 104 is specifically configured to:
perform text recognition processing on the first speech to obtain a third text; and
determine, based on the second text and the third text, a text content associated with the first speech.

Based on one or more embodiments of the present disclosure, the third obtaining module 103 is specifically configured to:
obtain sample identifications of a plurality of sample texts within the text set and sample text features corresponding to subsequent texts for the sample texts;
determine an initial set based on the sample identifications and the sample text features, wherein the initial set includes a plurality of sample identifications and a sample text feature corresponding to each sample identification; and
update, based on the plurality of sample texts, the plurality of sample text features within the initial set to obtain the first set.

Based on one or more embodiments of the present disclosure, the third obtaining module 103 is specifically configured to:
obtain a first sample identification corresponding to the first sample text and subsequent sample texts for the first sample text;
determine a first sample text feature within the initial set based on the first sample identification;
obtain a first frequency of occurrence of a combined text of the subsequent sample texts associated with the first sample text within the text set, as well as subsequent text features corresponding to the subsequent sample texts; and
update the first sample text feature based on the first frequency and the subsequent text features.

Based on one or more embodiments of the present disclosure, the third obtaining module 103 is specifically configured to:
determine an update proportion of the first sample text feature based on the first frequency; and
randomly update vectors in the first sample text feature based on the update proportion and the subsequent text features.

The speech recognition apparatus provided in this embodiment of the present disclosure may be used for performing the technical solutions in the above method embodiments, and the implementation principle and technical effects are similar to those as above, which are not further described in this embodiment.

FIG. 11 is a schematic diagram of a structure of an electronic device according to embodiments of the present disclosure. Referring to FIG. 11, which illustrates a schematic diagram of a structure of an electronic device 1100 suitable for implementing embodiments of the present disclosure. The electronic device 1100 may be an electronic device. The electronic device may include, but is not limited to, a mobile terminal such as a mobile phone, a notebook computer, a digital broadcast receiver, a personal digital assistant (PDA), a portable android device (PAD), a portable media player (PMP), and a vehicle-mounted terminal (e.g., a vehicle navigation terminal), and a fixed terminal such as a digital TV and a desktop computer. The electronic device shown in FIG. 11 is merely an example and should not impose any limitations on the functions and scope of use of this embodiment of the present disclosure.

As shown in FIG. 11, the electronic device 1100 may include a processing unit (e.g., a central processing unit and a graphics processing unit) 1101, which may perform various appropriate actions and processing according to programs stored in a read-only memory (ROM) 1102 or loaded from a storage unit 1108 into a random access memory (RAM) 1103. The RAM 1103 further stores various programs and data required for the operation of the electronic device 1100. The processing unit 1101, the ROM 1102, and the RAM 1103 are connected to one another through a bus 1104. An input/output (I/O) interface 1105 is also connected to the bus 1104.

Generally, the following units may be connected to the I/O interface 1105: an input unit 1106 including, for example, a touch screen, a touchpad, a keyboard, a mouse, a camera, a microphone, an accelerometer, and a gyroscope; an output unit 1107 including, for example, a liquid crystal display (LCD), a speaker, and a vibrator; the storage unit 1108 including, for example, a tape and a hard disk; and a communication unit 1109. The communication unit 1109 may allow the electronic device 1100 to perform wireless or wired communication with other devices to exchange data. Although FIG. 11 illustrates the electronic device 1100 with various units, it should be understood that it is not necessary to implement or have all the shown units. It may be an alternative to implement or have more or fewer units.

In particular, according to embodiments of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such embodiments, the computer program may be downloaded from a network through the communication unit 1109 and installed, installed from the storage unit 1108, or installed from the ROM 1102. The computer program, when executed by the processing unit 1101, performs the above functions defined in the method in the embodiments of the present disclosure.

It is to be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, where the data signal carries computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with the instruction execution system, apparatus, or device. The program code contained in the computer-readable medium may be transmitted by any suitable medium, including but not limited to: electric wires, optical cables, radio frequency (RF), etc., or any suitable combination thereof.

Optionally, an embodiment of the present disclosure further includes a speech system. The speech system includes a speech-to-text apparatus and the first dictionary according to any of the above embodiments, and the speech-to-text apparatus is configured to convert speech information into text information.

Optionally, an embodiment of the present disclosure further includes a computer-readable storage medium storing computer-executable instructions which, when executed by a processor, cause the processor to implement the method according to any of the above embodiments.

Optionally, an embodiment of the present disclosure further includes a computer program product, including a computer program. The computer program, when executed by a processor, implements the method according to any of the above embodiments.

Optionally, the electronic device in this embodiment of the present disclosure may include the above speech system, the computer-readable storage medium, or the computer program product.

The above computer-readable medium may be contained in the above electronic device; or may exist independently, without being assembled into the electronic device.

The above computer-readable medium carries one or more programs, and the one or more programs, when executed by the electronic device, cause the electronic device to perform the method shown in the above embodiment.

Computer program code for performing the operations in the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the electronic device. In the case of involving the remote computer, the remote computer may be connected to the user computer through any kind of network, including a local area network (LAN) or a wide area network (WAN), or may be connected to an external computer (e.g., utilizing an Internet service provider for Internet connectivity).

The flowchart and the block diagram in the accompanying drawings illustrate the possibly implemented architecture, functions, and operations of the system, the method, and the computer program product according to various embodiments of the present disclosure. In this regard, each block in the flowchart or the block diagram may represent a module, a program segment, or a part of code, and the module, the program segment, or the part of code contains one or more executable instructions for implementing specified logical functions. It should also be noted that, in some alternative implementations, the functions marked in the blocks may also occur in an order different from that marked in the accompanying drawings. For example, two blocks shown in succession may actually be performed substantially in parallel, or they may sometimes be performed in a reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof more specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof.

It is to be noted that the modifiers “one” and “a plurality of” mentioned in the present disclosure are illustrative and not restrictive, and those skilled in the art should understand that unless otherwise explicitly specified in the context, the modifiers should be understood as “one or more”.

The names of messages or information exchanged between a plurality of apparatuses in the implementations of the present disclosure are used for illustrative purposes only, and are not used to limit the scope of these messages or information.

It should be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, a prompt message is sent to the user to clearly inform the user that a requested operation will require access to and use of the personal information of the user. As such, the user may independently choose, based on the prompt message, whether to provide the personal information to software or hardware, such as a terminal device, an application, an electronic device, or a storage medium, that performs the operations of the technical solutions of the present disclosure.

As an optional but non-limiting implementation, in response to the reception of the active request from the user, the prompt message may be sent to the user in the form of, for example, a pop-up window, in which the prompt message may be presented in text. Furthermore, the pop-up window may also carry a selection control for the user to choose whether to “agree” or “disagree” to provide the personal information to the terminal device.

It should be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It should be understood that the data involved in the technical solutions (including but not limited to the data itself and the access to or use of the data) shall comply with the requirements of corresponding laws, regulations, and relevant provisions. The data may include information, parameters, messages, etc., such as stream splitting indication information.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in the context of a separate embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A speech recognition method, comprising:
obtaining a first speech;
obtaining a first text corresponding to a previous segment of speech of the first speech;
obtaining a first set, the first set comprising a plurality of text identifications and a text feature corresponding to each of the plurality of text identifications, the text feature being a feature associated with a plurality of subsequent texts of a text corresponding to the text identification, the text feature being associated with frequencies of the plurality of subsequent texts of the text in a text set, and the first set being determined based on the text set; and
determining, based on the first text and the first set, text content associated with the first speech.

2. The method of claim 1, wherein determining, based on the first text and the first set, the text content associated with the first speech comprises:
determining, based on the first text and the first set, a next segment of second text of the first text; and
determining, based on the second text and the first speech, the text content associated with the first speech.

3. The method of claim 2, wherein determining, based on the first text and the first set, the next segment of second text of the first text comprises:
obtaining a first identification of the first text;
obtaining, based on the first identification, a first text feature associated with a plurality of subsequent texts of the first text from the first set; and
determining the second text based on the first text and the first text feature.

4. The method of claim 3, wherein obtaining, based on the first identification, the first text feature associated with the plurality of subsequent texts of the first text from the first set comprises:
determining a target identification that is same as the first identification from the plurality of text identifications in the first set; and
determining a text feature corresponding to the target identification as the first text feature.

5. The method of claim 3, wherein determining the second text based on the first text and the first text feature comprises:
determining, based on the first text, a context feature associated with the first text; and
determining the second text based on the context feature and the first text feature.

6. The method of claim 5, wherein determining the second text based on the context feature and the first text feature comprises:
fusing the first text feature and the context feature to obtain a fused feature; and
determining the second text based on the fused feature.

7. The method of claim 2, wherein determining, based on the second text and the first speech, the text content associated with the first speech comprises:
performing text recognition on the first speech to obtain a third text; and
determining, based on the second text and the third text, the text content associated with the first speech.

8. The method of claim 1, wherein obtaining the first set comprises:
obtaining sample identifications of a plurality of sample texts in the text set and sample text features corresponding to subsequent texts of the sample texts;
determining an initial set based on the sample identifications and the sample text features, wherein the initial set comprises a plurality of sample identifications and a sample text feature corresponding to each sample identification; and
updating, based on the plurality of sample texts, the plurality of sample text features in the initial set to obtain the first set.

9. The method of claim 8, wherein for any first sample text among the plurality of sample texts, updating, based on the first sample text, the plurality of sample text features in the initial set comprises:
obtaining a first sample identification corresponding to the first sample text and subsequent sample texts of the first sample text;
determining a first sample text feature from the initial set based on the first sample identification;
obtaining a first frequency of occurrence of a combined text of the subsequent sample texts associated with the first sample text in the text set, and subsequent text features corresponding to the subsequent sample texts; and
updating the first sample text feature based on the first frequency and the subsequent text features.

10. The method of claim 9, wherein updating the first sample text feature based on the first frequency and the subsequent text features comprises:
determining an update proportion of the first sample text feature based on the first frequency; and
randomly updating vectors in the first sample text feature based on the update proportion and the subsequent text features.

11. (canceled)

12. An electronic device, comprising: a processor and a memory, wherein
the memory stores computer-executable instructions; and
the processor executes the computer-executable instructions stored in the memory, to cause the processor to:
obtain a first speech;
obtain a first text corresponding to a previous segment of speech of the first speech;
obtain a first set, the first set comprising a plurality of text identifications and a text feature corresponding to each of the plurality of text identifications, the text feature being a feature associated with a plurality of subsequent texts of a text corresponding to the text identification, the text feature being associated with frequencies of the plurality of subsequent texts of the text in a text set, and the first set being determined based on the text set; and
determine, based on the first text and the first set, text content associated with the first speech.

13. A non-transitory computer-readable storage medium, storing computer-executable instructions that, when executed by a processor, cause the processor to:
obtain a first speech;
obtain a first text corresponding to a previous segment of speech of the first speech;
obtain a first set, the first set comprising a plurality of text identifications and a text feature corresponding to each of the plurality of text identifications, the text feature being a feature associated with a plurality of subsequent texts of a text corresponding to the text identification, the text feature being associated with frequencies of the plurality of subsequent texts of the text in a text set, and the first set being determined based on the text set; and
determine, based on the first text and the first set, text content associated with the first speech.

14. The electronic device of claim 12, wherein the computer-executable instructions that cause the processor to determine, based on the first text and the first set, the text content associated with the first speech comprise instructions to:
determine, based on the first text and the first set, a next segment of second text of the first text; and
determine, based on the second text and the first speech, the text content associated with the first speech.

15. The electronic device of claim 14, wherein the instructions that cause the processor to determine, based on the first text and the first set, the next segment of second text of the first text comprise instructions to:
obtain a first identification of the first text;
obtain, based on the first identification, a first text feature associated with a plurality of subsequent texts of the first text from the first set; and
determine the second text based on the first text and the first text feature.

16. The electronic device of claim 15, wherein the instructions that cause the processor to determine the second text based on the first text and the first text feature comprise instructions to:
determine, based on the first text, a context feature associated with the first text; and
determine the second text based on the context feature and the first text feature.

17. The electronic device of claim 12, wherein the computer-executable instructions that cause the processor to obtain the first set comprise instructions to:
obtain sample identifications of a plurality of sample texts in the text set and sample text features corresponding to subsequent texts of the sample texts;
determine an initial set based on the sample identifications and the sample text features, wherein the initial set comprises a plurality of sample identifications and a sample text feature corresponding to each sample identification; and
update, based on the plurality of sample texts, the plurality of sample text features in the initial set to obtain the first set.

18. The non-transitory computer-readable storage medium of claim 13, wherein the computer-executable instructions that cause the processor to determine, based on the first text and the first set, the text content associated with the first speech comprise instructions to:
determine, based on the first text and the first set, a next segment of second text of the first text; and
determine, based on the second text and the first speech, the text content associated with the first speech.

19. The non-transitory computer-readable storage medium of claim 18, wherein the instructions that cause the processor to determine, based on the first text and the first set, the next segment of second text of the first text comprise instructions to:
obtain a first identification of the first text;
obtain, based on the first identification, a first text feature associated with a plurality of subsequent texts of the first text from the first set; and
determine the second text based on the first text and the first text feature.

20. The non-transitory computer-readable storage medium of claim 19, wherein the instructions that cause the processor to determine the second text based on the first text and the first text feature comprise instructions to:
determine, based on the first text, a context feature associated with the first text; and
determine the second text based on the context feature and the first text feature.

21. The non-transitory computer-readable storage medium of claim 13, wherein the computer-executable instructions that cause the processor to obtain the first set comprise instructions to:
obtain sample identifications of a plurality of sample texts in the text set and sample text features corresponding to subsequent texts of the sample texts;
determine an initial set based on the sample identifications and the sample text features, wherein the initial set comprises a plurality of sample identifications and a sample text feature corresponding to each sample identification; and
update, based on the plurality of sample texts, the plurality of sample text features in the initial set to obtain the first set.
